(19) United States
(12) Patent Application Publication
(10) Pub. No.: US 2025/0240233 A1
(43) Pub. Date: Jul. 24, 2025

(54) GEODESIC COORDINATES FOR ROUTING IN A SATELLITE CONSTELLATION

(71) Applicants: Francis Patrick KELLY, Cambridge (GB); HUAWEI TECHNOLOGIES CO., LTD., SHENZHEN (CN)

(72) Inventors: William Carson MCCORMICK, Kanata (CA); Francis Patrick KELLY, Cambridge (GB)

(73) Assignee: HUAWEI TECHNOLOGIES CO., LTD., SHENZHEN (CN)

(21) Appl. No.: 18/417,701

(22) Filed: Jan. 19, 2024

(51) Int. Cl. H04L 45/12; H04B 7/185

(52) U.S. Cl. CPC H04L 45/126; H04B 7/18521

(57) ABSTRACT

A method and apparatus for routing a data packet in a network, with device locations defined based on geodesics. The devices in the network may be satellites. Locations are defined for candidate devices for receiving the packet as well as a further (e.g. final) destination for the packet. The candidate device which is closest to the further destination can then be selected and the data packet routed to this device. The selecting may use a comparator tree. A distance metric for evaluating closeness may be determined using geodesic parameters representing the location of the candidate device and the location of the further destination. The geodesic parameters may represent the intersection of a pair of great circles which have a same inclination as orbital paths of the devices as satellites.

### CROSS-REFERENCE TO RELATED APPLICATIONS

This is the first application filed for the present invention.

### FIELD OF THE INVENTION

The present invention pertains to (e.g. packet-based) data networks, such as satellite networks, and in particular to a method and apparatus for supporting routing in such networks.

### BACKGROUND

Satellite constellations can be used to provide, among other things, routing services for connectivity in a packet-based network such as the Internet. It is currently proposed that a group of satellites would be distributed in space and organized into a mesh network. Free space optical (i.e. laser) links are proposed as one way for providing high-bandwidth network connectivity between satellites. Other types of links, such as radiofrequency or microwave-based links are also possible. Use of low Earth orbit (LEO) satellite systems generally leads to lower latency than medium Earth orbit (MEO) or geostationary orbit (GEO) systems, but requires large numbers of satellites.

Similarly to terrestrial networks, a data packet can be routed through a satellite network along a variety of paths. Because the satellites are moving rapidly with respect to the surface of the Earth, routing of packets toward a destination requires consideration of satellite locations. Rapidly computing effective routing paths in such scenarios is computationally intensive and current routing methods are subject to improvement and customization to satellite networking.

Geographic routing involves routing of packets based on geographic position information without necessarily relying on knowledge of network topology. As such, use of geographic coordinates is subject to challenges in aligning with the network topology and can result in routing problems, such as black holes. In addition, such methods are subject to improvement in terms of computational efficiency, applicability to scenarios to satellite mesh networks, or both.

Routing based on network topology, on the other hand, while being in alignment with network topology by definition, presents challenges in estimating actual distances between satellites.

Therefore, there is a need for a method and apparatus for supporting routing and forwarding in satellite networks and similar networks that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a method and apparatus for routing a packet or packets in a network including satellite network nodes. In some embodiments, the routing involves identifying and selecting a next network node from among a plurality of potential next network nodes and forwarding the packet toward that selected next network node. The next network node can be selected based on its status as being the closest node, among the plurality, to a destination node, such as a final destination of the packet, e.g. as expressed via the packet's destination address field. In order to support such operation, or another routing methodology, locations of the potential next network nodes and the destination node are determined. In particular, the locations are defined using geodesic coordinates. In more detail, two geodesics are defined which intersect at a node's location. The geodesics have an angle of inclination which is the same as an angle of inclination of satellite network nodes. The location is then defined by the locations (e.g. expressed as longitudes) at which these geodesics intersect the equator. Such intersections are expressed as respective angles measured along the equatorial plane centred at the centre of a sphere (e.g. Earth) from a common reference location, such as the intersection of the prime meridian (also known as Greenwich meridian) with the equator (i.e. 0° latitude and 0° longitude), for example. A distance metric is also defined between two such locations or nodes defined by respective geodesics. The distance metric may be a Manhattan (i.e. L1) distance metric as defined for example in Equations (3) to (5) set forth below.

In accordance with embodiments of the present disclosure, there is provided a method for routing a data packet in a network. The method includes, for each one of a plurality of destination devices capable of further handling of the data packet for routing toward a further destination, determining a respective cost or utility associated with forwarding the data packet to said one of the plurality of destination devices. Determining the cost or utility comprises computing a distance metric from said one of the plurality of destination devices to the further destination using the location of said one of the plurality of destination devices and the location of said further destination. The method further includes selecting one of the plurality of destination devices based at least in part on the determined costs or utilities, and forwarding the data packet to said selected one of the plurality of destination devices.

In accordance with embodiments of the present disclosure, there is provided an apparatus for forwarding a data packet in a network. The apparatus includes a cost determiner configured, for each one of a plurality of destination devices capable of further handling of the data packet for routing toward a further destination, to determine a respective cost or utility associated with forwarding the data packet to said one of the plurality of destination devices. The cost or utility is determined at least in part by computing a distance metric from the one of the plurality of destination devices and the further destination using the location of the one of the plurality of destination devices and the location of the further destination. The apparatus further includes a destination selector configured to receive the determined costs or utilities from the cost determiner and select one of the plurality of destination devices based at least in part on the determined costs or utilities. The apparatus further includes a packet forwarder configured to receive an indication of the selected one of the plurality of destination devices from the destination selector and forward the data packet to the selected one of the plurality of destination devices. One or both of the cost determiner and the destination selector may be implemented using a processor operatively coupled to a memory, the memory storing program instructions that, when executed by the processor, cause the processor to implement one or both of the cost determiner and the destination selector. One or both of the cost determiner and the destination selector may be implemented using dedicated data processing hardware.

In accordance with embodiments of the present disclosure, there is provided a method for assigning an address to a node in a network. The method includes determining a first parameter representing location of an intersection of an equatorial plane with a first geodesic passing through the node, determining a second parameter representing location of an intersection of the equatorial plane with a second geodesic passing through the node, and assigning the address so as to include the first parameter and the second parameter. Thus, network addresses are based on geographic location, specified in a certain manner. This allows for geographic routing.

In accordance with embodiments of the present disclosure, said one of the plurality of destination devices has a location defined by a first parameter α₁ representing location of an intersection of an equatorial plane with a first geodesic passing through said one of the plurality of destination devices, and a second parameter β₁ representing location of an intersection of the equatorial plane with a second geodesic passing through said one of the plurality of destination devices.

In accordance with embodiments of the present disclosure, the further destination has a location defined by a further first parameter α₂ representing an intersection of the equatorial plane with a further first geodesic passing through the further destination, and a further second parameter β₂ representing an intersection of the equatorial plane with a further second geodesic passing through the further destination.

In accordance with embodiments of the present disclosure, selecting one of the plurality of destination devices includes selecting a particular one of the plurality of destination devices having a lowest cost or highest utility.

In accordance with embodiments of the present disclosure, selecting said one of the plurality of destination devices includes using a comparator tree having multiple stages, each stage having one or more comparators configured to compare pairs of said costs or utilities and output an indication of a lower of compared costs or a higher of compared utilities.

In accordance with embodiments of the present disclosure, at least one of: the plurality of destination devices; and the further destination is a satellite-based network node.

In accordance with embodiments of the present disclosure, a plane comprising the first geodesic of the one or more of the plurality of destination devices is representative of an orbital plane of at least one of the one or more of the plurality of destination devices.

In accordance with embodiments of the present disclosure, the second parameter β₁ is based on an angular position ϕ₁ of the one of the plurality of destination devices. The angular position ϕ₁ is determined or measured relative to a location corresponding to the first parameter α₁. The second parameter β₁ is based on an inclination θ of the orbital plane of the at least one of the one or more of the plurality of destination devices.

In accordance with embodiments of the present disclosure, the plurality of destination devices or nodes belongs to the network. Each destination device or node in the plurality of destination devices or nodes follows a respective orbit having a same orbital inclination θ.

In accordance with embodiments of the present disclosure, the distance metric d is computed according to:

$$Δ α = min ( \vert {α}_{1} - {α}_{2} \vert , 2 π - \vert {α}_{1} - {α}_{2} \vert ) \qquad ( 3 )$$

$${Δ}_{Y} = min ( 2 \vert {γ}_{1} - {γ}_{2} \vert , 4 π - 2 \vert {γ}_{1} - {γ}_{2} \vert ) \qquad ( 4 )$$

$$d = Δα + Δγ \qquad ( 5 )$$

where α₁ is the first parameter, α₂ is the further first parameter, and γ₁ is an additional parameter defined such that β₁=α₁+2γ₁, where β₁ is the second parameter. γ₂ is a further additional parameter defined such that β₂=α₂+2γ₂, where β₂ is the further second parameter.

In accordance with embodiments of the present disclosure, the additional parameter γ₁ is computed according to

$$tan {γ}_{1} = \frac{cos θ sin {ϕ}_{1}}{cos {ϕ}_{1}} ,$$

where θ is an orbital inclination of the one of the plurality of destination devices or the further destination, or both. Respective phase ϕ₁ is an angular position of the one of the plurality of destination devices relative to a location corresponding to the first parameter α₁. The further additional parameter γ₂ is computed according to

$$tan {γ}_{2} = \frac{cos θ sin {ϕ}_{2}}{cos {ϕ}_{2}} ,$$

where ϕ₂ is an angular position of said further destination relative to a location corresponding to the further first parameter α₂.

In accordance with embodiments of the present disclosure, the first geodesic and the second geodesic intersect at one of: vertically below; vertically above and at said one of the plurality of destination devices.

In accordance with embodiments of the present disclosure, each parameter represents an angle measured in the equatorial plane from a common reference location to each respective intersection of the equatorial plane with the respective geodesic passing through the one of the plurality of destination devices.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1A is a schematic illustration of (e.g. satellite) network node positions in orbit, according to embodiments of the present disclosure.

FIG. 1B is a schematic illustration of (e.g. satellite) network node in orbit, according to embodiments of the present disclosure.

FIGS. 2A-H are schematic illustrations of node positions in orbit with respective geodesics at each node position, according to embodiments of the present disclosure.

FIG. 3 is a graph illustrating first geodesic parameter α and second geodesic parameter β of a node moving in its orbit, according to embodiments of the present disclosure.

FIG. 4 is a graph illustrating distance metric from node 1 to node 2 and node 3 as nodes move in their respective orbits, according to embodiments of the present disclosure.

FIG. 5 is a schematic illustration of a method for routing a data packet in a network, according to embodiments of the present disclosure.

FIG. 6A is a block diagram illustrating forwarding plane operation, according to an embodiment of the present disclosure.

FIG. 6B is a block diagram illustrating forwarding plane operation, according to another embodiment of the present disclosure.

FIG. 7 is a schematic illustration of an apparatus for routing a data packet in a network, according to embodiments of the present disclosure.

FIG. 8 is a schematic illustration of an electronic device that may perform any or all of operations of the methods and features explicitly or implicitly described herein, according to embodiments of the present disclosure.

It will be noted that throughout the appended drawings, like features are identified by like reference numerals.

### DETAILED DESCRIPTION

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to.

This application incorporates by reference in its entirety the applicants' prior U.S. patent application entitled Packet Forwarding Based on Geometric Location, Ser. No. 16/721,171, filed Dec. 19, 2019.

Satellite-based networks potentially provide global connectivity and may also provide new coverage extensions in Fifth Generation (5G) and Sixth Generation (6G) communications technologies, as defined for example by the 3rd Generation Partnership Project (3GPP). Overall industry interest is to deploy inter-satellite links to route user traffic over multiple satellites. In this regard, use of low Earth orbit (LEO) satellite systems may be appropriate, as such systems have lower round trip latency and lower launch costs compared to medium Earth orbit (MEO) and geostationary Earth orbit (GEO) systems. Very low Earth orbit (VLEO) systems also have potential to be utilized for such purposes. However, an effective global network requires potentially large numbers of LEO satellites, each moving at relatively high ground speed. Furthermore, the dynamic nature of satellite network constellations presents challenges for existing routing protocols due, for example, to the existence of an orbital seam, the size of network, and the requirement to timely communicate network changes to all nodes as they occur.

While GEO satellites are stationary with respect to the surface of the Earth, MEO, VLEO and LEO satellites are considered to be mobile with some time periodicity. That is, MEO, VLEO and LEO satellites pass over the same point of the Earth after a specific time period which is dependent on their altitude. LEO and potentially VLEO satellites can provide global coverage over the Earth and are capable of reusing frequency more effectively. LEO (and potentially VLEO) satellite networks can provide ubiquitous connectivity with low latency. A characteristic of these satellite networks is that many satellites are typically needed to provide global coverage, mainly due to the low altitude of the individual satellites.

In satellite communication technologies, a satellite constellation is defined as a group of satellites with coordinated ground coverage and shared control rotating in (e.g. LEO, VLEO) orbits. Two main satellite constellations currently utilized are “polar constellation” and “Walker-Delta constellation”. Walker-Delta constellations are thought to provide better uniform coverage over the Earth almost everywhere except poles, where no coverage is provided. Polar constellations however provide a dense coverage over the poles and less dense coverage over the equator. A Walker-Delta constellation can be characterized in part by the inclination of its satellite orbits, with higher inclinations resulting in coverage extending correspondingly nearer to the poles.

Satellite network nodes may have two types of interfaces: Ground communication interfaces, and Inter-satellite link (ISL) communication interfaces. The ground communication interfaces can be microwave systems operating in X-band or ka-band. The ISL interfaces can use communication lasers and can provide for high-speed optical free-space communication links between the satellite nodes. The ISL interfaces may utilize radio-frequency inter-satellite links. ISL links include intra-orbit links, i.e. links between (typically adjacent) satellites in a common orbit but spaced apart, and inter-orbit links, i.e. links between satellites in different (typically adjacent for at least a period of time) orbits.

Due to the dynamic nature of the satellite networks, the ISL characteristics also change dynamically. Even for intra-orbit ISLs where link distance is constant, the link behavior may change as the satellites pass over different parts of the Earth (e.g. at the poles). The dynamic range of characteristics for the ISLs is significantly larger for inter-orbit ISLs for both polar and Walker-Delta constellations. Due to the dynamically changing ISL links, attributes of the network topology in satellite networks are considered to change dynamically. The impact of network topology changes, link failures and link creations, link level optical impairments as well as Doppler Effect makes packet routing a significant challenge in satellite networks. This is particularly the case in dense LEO satellite networks where network events are frequent. Packet addressing is another challenge. Additionally, satellite onboard processing capability is limited and therefore it is desirable to limit the amount of onboard processing that is required to perform functions such as network routing.

When using a satellite network to route a packet to a (e.g. ground-based) destination, it is notable that the satellite constellation typically moves rapidly relative to such a destination. This makes it challenging to determine, at a given time, which path to forward the packet on so that it efficiently reaches the destination. For example, it may be desirable to determine which target satellite (i.e. node or destination) is currently closest (or adequately close) to a further (e.g. final) destination so that the packet can be routed along a path toward that target satellite. Constellation geometry can be used to facilitate such routing, for example.

In particular, according to embodiments of the present disclosure, the satellite constellation can be configured to route packets toward a target or selected node (or device) which is determined to be closest to the destination location (or device) based on a corresponding distance metric. To facilitate this, a satellite (or satellite address) is assigned geodesic coordinates (or parameters) which comprise two geodesic parameters used in determining the distance metric. These geodesic parameters coordinates can be (at least) part of the destination address, for example. Accordingly, the satellite may take on an address indicative of its physical location, expressed using geodesic coordinates (or parameters), and the address can be used for routing purposes. The packet destination can similarly take on such an address. Such geodesic routing can also be used in other scenarios. According to such geodesic routing, a data packet specifies geodesic parameters of a destination, for example in a header thereof.

As used herein, the terms “first parameter”, “second parameter”, and “additional parameter” are interchangeable with “first geodesic parameter”, “second geodesic parameter”, and “additional geodesic parameter”, respectively. The first, second and additional parameters are denoted by α, β and γ, respectively.

Packet routing often involves a node (e.g. a satellite), when in possession of a packet, identifying a next-hop node to which to forward the packet. This next-hop node should be nominally “closer” to a target node (e.g. target satellite) and final packet destination than the current node. The target node can be selected as a node, which is within a limited local neighbourhood of the node holding the packet, and which is closest to the final packet destination (i.e. having the smallest distance metric), or among the closest nodes to the final packet destination (i.e. having the smallest distance metric). Routing tables can be maintained for the purpose of identifying suitable next-hop nodes based on packet destination information. Distributed link-state routing protocols, such as open shortest path first (OSPF) protocols, can be used to maintain routing tables. Link state information can be shared between nodes using control plane messaging.

In networks involving mobile nodes, such as orbiting (e.g. LEO) satellite nodes, the relative motion of nodes with respect to each other, ground nodes, or both, can result in time-varying network topology and link availability. Maintaining routing tables and link state information globally therefore becomes a challenging task. It is therefore useful to consider alternative routing methods, which can be implemented using limited information. The limited information may include node location and link state information for only those nodes in a local neighbourhood of a given node making a routing decision. For example, according to embodiments of the present disclosure, each network node maintains node location and link status information for a limited portion of the network that is local to that network node. The packet specifies its destination location, for example using geodesic coordinates (or parameters) in a header thereof. As such, a network node can determine a value for a distance metric from each node in its local neighbourhood to a destination having converted its location, if needed, to geodesic coordinates.

Embodiments of the present disclosure provide for assigning geodesic coordinates to devices such as (e.g. satellite) network nodes. The geodesic coordinates include two geodesic parameters for address assignment, packet routing and forwarding, or a combination thereof, in a network. In the context of embodiments of the present disclosure, a geodesic is defined as a curve representing the shortest distance between two points on a surface of a sphere. In embodiments, such curve belongs to a circle centered at the origin of a sphere (e.g. representing the center of Earth). The geodesic may alternatively be referred to as a great circle or portion thereof.

In embodiments, geodesic coordinates include two geodesic parameters.

In embodiments, the two geodesic parameters include a first (geodesic) parameter α and a second (geodesic) parameter β. Geodesic parameters can be determined from a position or location of a node, such as a satellite, or a destination (e.g. as indicated in a packet header).

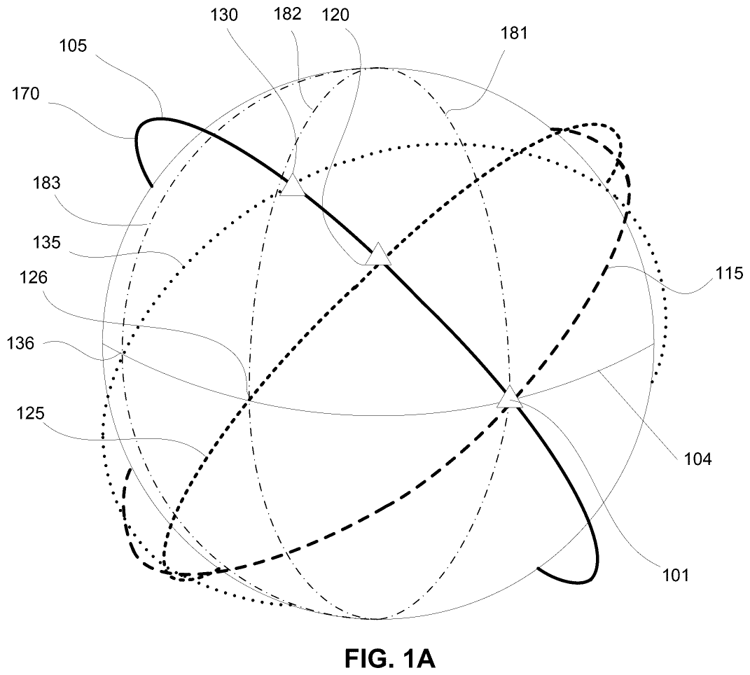

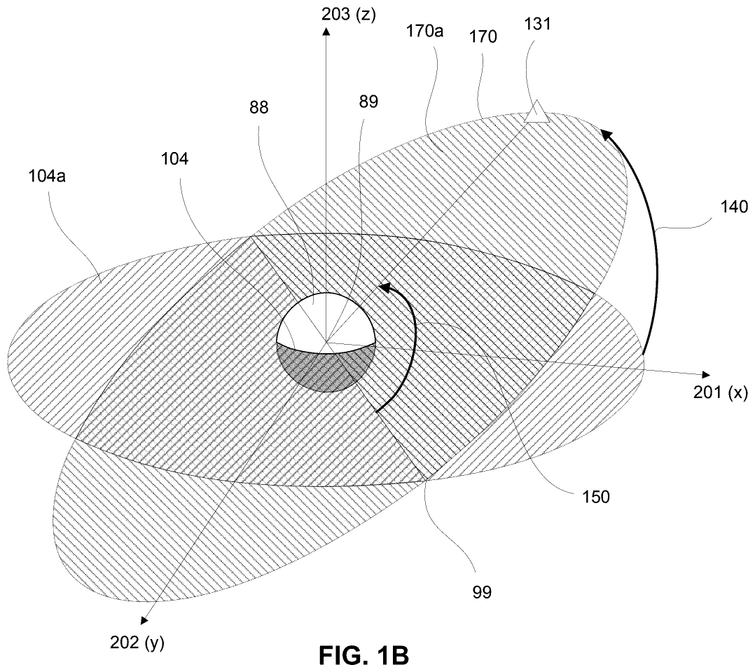

In embodiments, the first geodesic parameter is chosen such that it corresponds to or represents location of an intersection of a first geodesic passing through the node (or destination) with the equatorial plane. The first geodesic parameter may, for example, represent or correspond to the longitude of such intersection. In the context of FIG. 1A, for example, with the equator 104 and the first geodesic 105, the first geodesic parameter may be the longitude 181 of location 101, for all node positions 120, 130 and at location 101. More generally, the first geodesic parameter is expressed as an angle formed between two line segments lying within the equatorial plane and meeting at Earth's center, where one of the line segments passes through a reference location such as the intersection of the prime meridian (also known as Greenwich meridian) with the equator (i.e. 0° latitude and 0° longitude), for example, and the other line segment passes through the location of intersection of the first geodesic with the equator. Another common reference location or point may also be used.

In embodiments, the second geodesic parameter corresponds to or represents location of an intersection of a second geodesic passing through the node (or destination) with the equatorial plane. Again in the context of FIG. 1A, the second geodesic for node in location 101 is the geodesic 115, with the corresponding second geodesic parameter being the longitude 181 (shown as a meridian) of location 101 where the second geodesic intersects the equator 104. Similarly, the second geodesic for node position 120 is the geodesic 125, with the corresponding second geodesic parameter being the longitude 182 (shown as a meridian) of point 126 where the second geodesic intersects the equator 104. Similarly, the second geodesic for node position 130 is the geodesic 135, with the corresponding second geodesic parameter being the longitude 183 (shown as a meridian) of point 136 where the second geodesic intersects the equator 104. More generally, the second geodesic parameter is expressed as an angle formed between two line segments lying within the equatorial plane and meeting at Earth's center, where one of the line segments passes through a reference location such as the intersection of the prime meridian (also known as Greenwich meridian) with the equator (i.e. 0° latitude and 0° longitude), for example, and the other line segment passes through the location of intersection of the second geodesic with the equator. Another common reference location may also be used. Geodesic parameters share the same common reference location. The first and second geodesics have the same angle of inclination relative to the equator in a sense that is explained elsewhere herein. Notably, if the node orbits by following the path of the first geodesic 105 (and, in this example, corresponding orbit 170), the second geodesic will move according to a rotation about the north-south axis of the Earth.

Therefore, in embodiments, the first and second geodesic parameters represent an angle measured in the equatorial plane from the common reference location (e.g. prime meridian) to the intersection of the equatorial plane with the first geodesic passing through the node and the second geodesic passing through the node, respectively.

In embodiments, the first geodesic and the second geodesic may intersect vertically (altitude-wise) below, above, or at the node or destination. For example, embodiments described herein apply to Earth if it were a perfect sphere and, therefore, the intersection of the two geodesics through the node may be a three-dimensional approximation of the physical location of the node or destination. In embodiments, therefore the first geodesic and the second geodesic are circular approximations of a physical orbit around Earth.

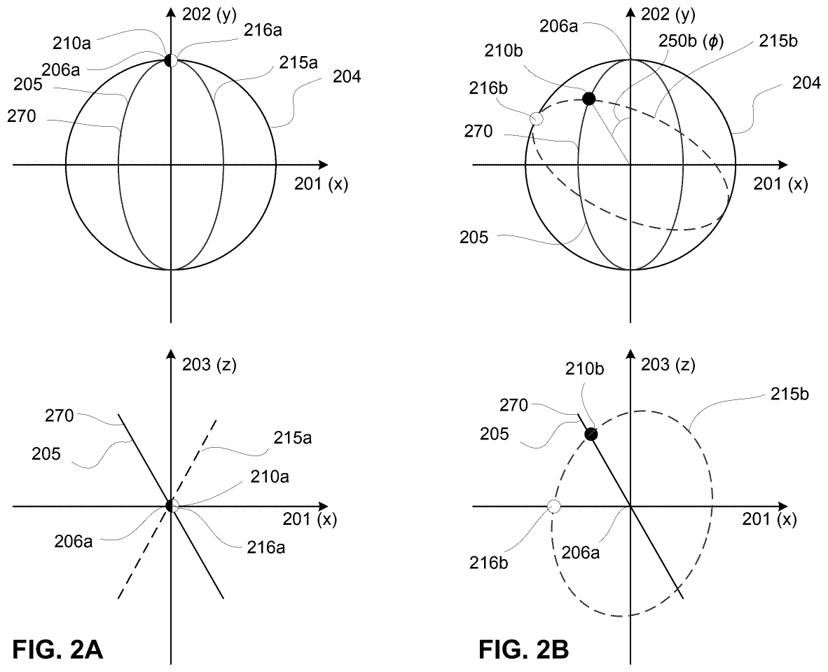

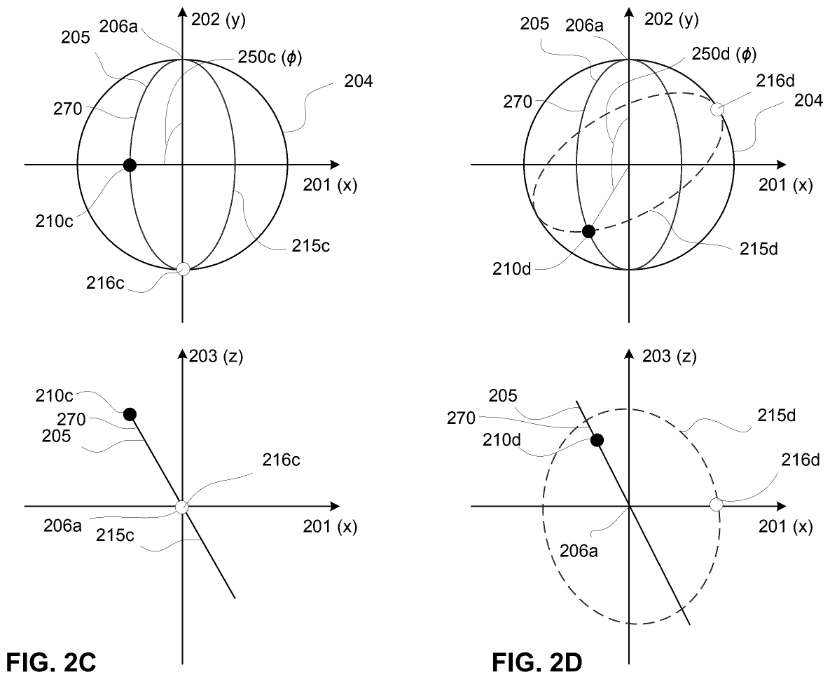

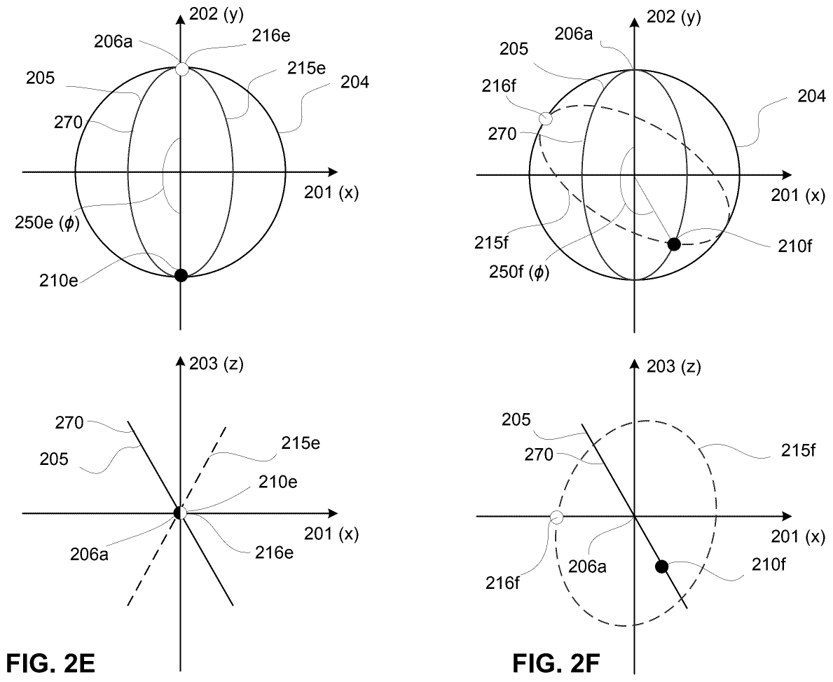

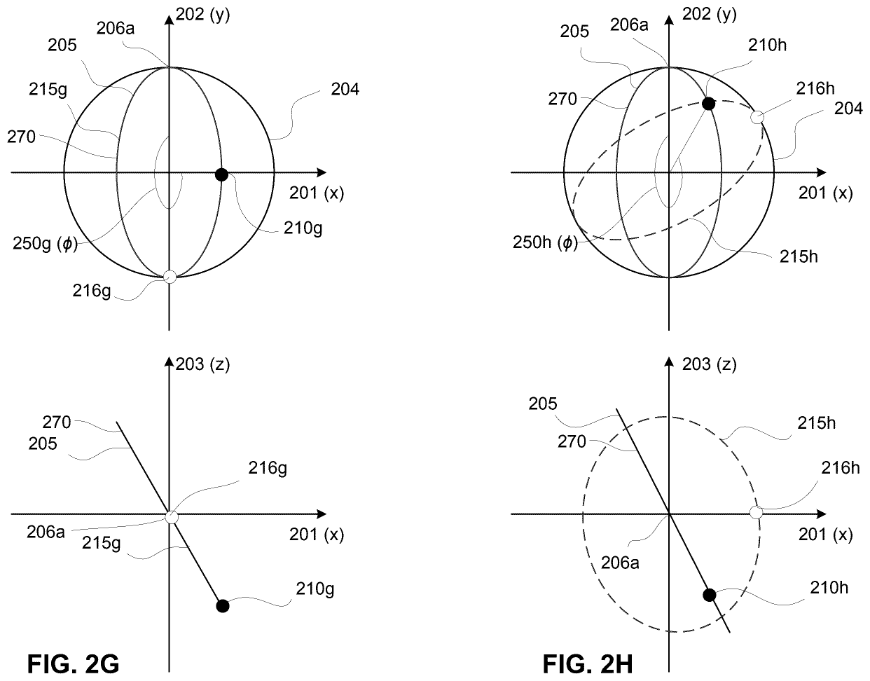

In embodiments, the first and second geodesic passing through the (e.g. orbiting) node or destination have an equal orbital tilt or (orbital) inclination θ relative to the equatorial plane. The inclination may be expressed as the angle between the equatorial plane (as reference plane) and the plane in which the orbit of a relevant network node (satellite) lies. The first geodesic for a satellite may actually lie within (and is representative of) the satellite's orbit. However, the second geodesic for that satellite will only line up with the satellite's orbit for certain satellite locations, e.g. as shown in FIGS. 2C and 2G. Otherwise, the second geodesic will have the same inclination as the first geodesic but will be rotated about Earth's vertical axis (e.g. z-axis, axis of rotation) as shown for example in FIG. 1A and FIGS. 2A-2B, 2D-2F and 2H. Same inclination may be alternatively described as covering a same range of latitudes, in the sense that the geodesics pass over a continuum of locations on or over Earth, each having a latitude, and the northernmost and southernmost latitudes so covered are the same for both geodesics.

In embodiments, geodesic parameters of nodes in a (e.g. satellite) network are defined by geodesics on a sphere having the same inclination as node orbits.

In embodiments, a plane containing the first geodesic passing through the node or destination is representative of or corresponds to the orbital plane of the node or destination. Such an orbital plane of the node or destination may be, for example, the physical orbital plane of the node or destination orbiting a sphere (e.g. Earth). Such an orbital plane and the orbit it corresponds to may be constant or predefined for a given node or destination.

In some embodiments, an orbital plane of the node or destination may be representative of the physical orbital plane of the node or destination as if it were orbiting a sphere (e.g. Earth). In such embodiments, the node or destination may be stationary or stationary over a period of time, for example.

In some embodiments, the node or a final (also referred to as further) destination may be on Earth's surface. Notably, the geodesic parameters can be used to specify the location of a node in orbit or on Earth surface, or at any other location. The altitude of the node or location is not directly specified by the geodesic parameters, but can be inferred through other means, if necessary. A non-satellite node, terrestrial packet destination, or the like, can be assigned geodesic parameters indicative of location as follows. A first geodesic can be defined which passes directly through or overhead of the node or destination's location, and which has the inclination θ that is the same as a corresponding satellite constellation communicatively coupled to the node or destination. A second geodesic can similarly be defined which also passes directly through or overhead of the node or destination's location, and which also has the inclination θ. The first and second geodesic parameters are then defined according to the locations of intersection of these two geodesics with the equator.

In embodiments, the first geodesic parameter is represented by α, where α∈[0, 2π).

In embodiments, the location of the node or destination is further defined by a second geodesic parameter β which is given a range of β∈[α−2π, α+2η), for example. The range is chosen for the second parameter β such that the entire orbit of the orbiting node can be addressed with a constant value of the first parameter α while accounting for the node's positions in every quadrant, above and below the equator. A possible benefit of using such range for β coordinate is ability to determine geodesic parameters for an orbiting node anywhere in an orbit, whether in northern or southern hemisphere. Another possible benefit is providing consistency in determining which of the two intersections of each geodesic with the equator to use in determining the geodesic parameters of a given location in orbit or location of the node or destination. The use of geodesic parameters to specify locations is not necessarily restricted to locations of nodes in an orbit. However, the location of a node in a given orbit can be specified using a first geodesic parameter which is substantially constant and a second geodesic parameter which varies as the node moves through the orbit.

FIG. 1A illustrates positions of a satellite node in its orbit around Earth. Location 101 represents the node in its orbit 170 at the equator 104. For such location of the node, a first geodesic 105 through the node intersects the equator 104 at the same location 101 as the node. Location 101 can be given a value, for example, of a first longitude 181 crossing the equator at location 101. Therefore, the location 101 corresponds to the first (geodesic) parameter α defining the node location. It is noted that the first geodesic 105 here is coincident with the node orbit 170. A second geodesic 115 through the node, when in the first position at the location 101, intersects the equator 104 also at the same location 101 and can be represented by the same value as the first longitude 181. Therefore, location 101 also corresponds to the second (geodesic) parameter β further defining the node location, which in this case is the same as the node's first position and intersection of the first geodesic 105 with the equator 104.

As the node moves up (generally northward) in its orbit 170 to a second position 120, the first geodesic 105 and its corresponding intersection with the equator 104 at the location 101 having the value of the first longitude 181 is unchanged. The second geodesic 125 through the second node position 120 intersects the equator 104 at point 126 corresponding to the second parameter β representative of the second node location 120. Point 126 can be given a value, for example, of a second longitude 182 crossing the equator at point 126.

As the node moves further up in its orbit 170 to a third position 130, the first geodesic 105 and its corresponding intersection with the equator 104 at the location 101 having the value of the first longitude 181 is unchanged. The second geodesic 135 through the third node position 130 intersects the equator 104 at point 136 corresponding to the second parameter β representative of the third node location 120. Point 136 can be given a value, for example, of a third longitude 183 crossing the equator at point 136.

FIG. 1B illustrates a (e.g. satellite) node in a position 131 in its orbit 170 centered at the center 89 of a sphere 88 (e.g. Earth). The orbit 170 of the node has a corresponding orbital plane 170a which intersects the equatorial plane 104a that includes the equator 104 centered at the center of the sphere 88. The position 131 of the node in its orbit 170 depends on and can be represented in part by a phase or angular position ϕ 150, which is an angle measured within the orbital plane 170a from an equatorial (e.g. starting) position 99 of the node to the position 131 of the node. The position 131 of the node in its orbit 170 further depends on and can be represented by an orbital tilt or inclination θ 140, which is an angle between the equatorial plane 104a and the orbital plane 170a of the node.

In embodiments, all orbiting (e.g. groups of) destination devices or nodes of a network that includes or consists of destination devices or nodes (e.g. a satellite constellation) have the same constant orbital tilt or inclination. Such inclination is a parameter of the network. The orbital inclination is typically given a range of 0° and 90° (or 0 and π/2 radians), where inclination of 0° (or 0 radians) corresponds to an orbit lying within the equatorial plane, and inclination of 90° (or π/2 radians) corresponding to an orbit passing through the north and south poles. The network of nodes may include numerous (e.g. groups of) nodes following individual orbits of a same orbital inclination, while having different respective intersections of orbits with the equatorial plane (e.g. different locations of (e.g. starting) equatorial position 99 in FIG. 1B). In illustrative example or FIG. 1B, an orbit within equatorial plane 104a (defined by x-axis 201 and y-axis 202) would have an orbital inclination of 0° (or 0 radians) (not shown), while any orbit comprising the z-axis 203 would have an orbital inclination of 90° (or π/2 radians) (not shown). Numerous different orbits with the same orbital tilt can be established, corresponding to different versions of the orbital plane 170a each with the same orbital tilt but rotated differently about the z-axis in FIG. 1B.

In embodiments, a plane comprising the first geodesic passing through a node is representative of an orbital plane of at least one of a one or more of the plurality of nodes or destination devices in a network. The first geodesic passing through the node is representative of the orbital plane of the node.

In an embodiment, the plane comprising the first geodesic passing through the node may be coincident with the orbital plane of the node.

In an embodiment, the first geodesic passing through the node may be coincident with the orbital plane of the node.

In embodiments, a plane comprising the first geodesic passing through the node may be representative of the orbital plane of one or more nodes of a network of nodes. For example, a network of nodes may be a satellite constellation where one group of satellites follows a same orbit in succession; while other groups in the constellation also follow their respective (same for a group) orbits in succession. For such a group of satellites having the same orbit, a first geodesic (and corresponding first geodesic parameter) is the same for each satellite in the group, while a second geodesic (and corresponding respective second and additional geodesic parameters for each satellite in the group) is individual to each satellite in the group at a given time. An example of such constellation where a group of satellites follow a same orbit in succession is a Starlink™ constellation.

The first geodesic can be altered to reflect different locations, such as but not necessarily limited to different satellite orbits or different ground locations. Such alteration can involve adjusting the location (e.g. longitude, angle measured along equator from a reference point) α of intersection of the first geodesic with the equator. Accordingly, in some embodiments a parameter pair (α, β) may specify a substantially arbitrary geographic or orbital location. Depending on the (fixed) inclination θ, a corresponding limited range of such locations (away from the poles) may be specified.

FIGS. 2A-2H show positions of a node along orbit 270 having inclination θ of π/3 with corresponding values of the second geodesic parameter β viewed along z-axis 203 (i.e. xy plane view) and along y-axis 202 (i.e. xz plane view), according to an example embodiment. A right-handed rotation is chosen here, with positive z-axis pointing out of the page in xy plane view, with angles measured from a common reference point chosen here to be the positive x-axis 201. In this example orbit 270 crosses the equator 204 at x=0. In FIGS. 2A-2H the first geodesic 205 through the node is illustrated as being coincident with the orbit 270. Because the node in this example follows an orbit matching the first geodesic, the first geodesic parameter α is constant at π/2 and represents the intersection 206a of the first geodesic 205 with the equator 204.

In FIG. 2A, the node position 210a is at the equator 204 (xy plane) and represents the starting position of the node moving in its orbit. The corresponding second geodesic parameter β is represented by the intersection 216a of the second geodesic 215a (through the node position 210a) with the equator 204 and is the same as the first geodesic parameter α 206a in this case. For illustrative purposes, the second geodesic 215a here may be viewed as the first geodesic 205 rotated by 180 degrees about the z-axis 203 while maintaining the constant inclination θ of π/3. It is noted that points 206a, 210a, 216a are co-located in FIG. 2A, but are distinguished here for purposes of clarity in view of the discussion below.

In FIG. 2B, the node position 210b has phase ϕ 250b of π/4, representative of an orbiting node ⅛^{th} of the way along in its orbit. The corresponding second geodesic parameter β is represented by the location (e.g. longitude) of intersection 216b of the second geodesic 215b through the node position 210b with the equator 204. The phase ϕ is used to describe the angular displacement (in radians) of the node, within its orbital plane, from its starting location in FIG. 2A.

In FIG. 2C, the node position 210c has phase ϕ 250c of π/2, representative of an orbiting node ¼^{th} of the way along in its orbit. The corresponding second geodesic parameter β is represented by the intersection 216c of the second geodesic 215c through the node position 210c with the equator 204. Notably, at this point, the two geodesics 205 and 215c overlap completely, and thus there is a continuum of intersection points of the two geodesics. In this case, the node position can be determined, for example, by taking a limit as the node approaches the equator along its predefined and known (e.g. from a satellite constellation geometry) orbit and direction of motion in the orbit.

In FIG. 2D, the node position 210d has phase ϕ 250d of 3π/4, representative of an orbiting node ⅜^{th} of the way along in its orbit. The corresponding second geodesic parameter β is represented by the intersection 216d of the second geodesic 215d through the node position 210d with the equator 204. The node is now moving downward.

In FIG. 2E, the node position 210e has phase ϕ 250e of a, representative of an orbiting node ½ of the way along in its orbit. The corresponding second geodesic parameter β is represented by the intersection 216e of the second geodesic 215e through the node position 210e with the equator 204. The node is now crossing into the southern hemisphere.

In FIG. 2F, the node position 210f has phase ϕ 250f of 5π/4, representative of an orbiting node ⅝^{th} of the way along in its orbit. The corresponding second geodesic parameter β is represented by the intersection 216f of the second geodesic 215f through the node position 210f with the equator 204.

In FIG. 2G, the node position 210g has phase ϕ 250g of 3π/2, representative of an orbiting node ¾ of the way along in its orbit. The corresponding second geodesic parameter β is represented by the intersection 216g of the second geodesic 215g through the node position 210g with the equator 204.

In FIG. 2H, the node position 210h has phase ϕ 250h of 7π/4, representative of an orbiting node ⅞^{th} of the way along in its orbit. The corresponding second geodesic parameter β is represented by the intersection 216h of the second geodesic 215h through the node position 210h with the equator 204. The node is now moving upward again from its southernmost position, back toward the position of FIG. 2A.

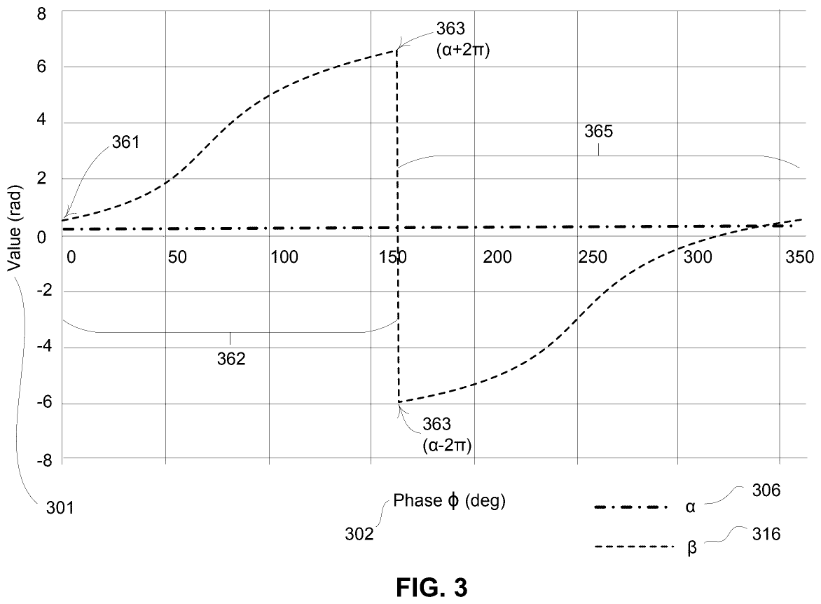

FIG. 3 shows value 301 of geodesic parameters α 306 and β 316 as a function of phase ϕ 302 for an orbiting node moving in its orbit having inclination θ of π/3, according to an example embodiment. The value of the first geodesic parameter α 306 is constant at π/10 as the orbital position and phase 302 of the node changes. In the present case the value of α corresponds to an angle, measured in radians, from a reference point or location which is chosen here as the intersection of the equator with the prime meridian (i.e. 0° latitude and 0° longitude), as already described above. Other orbits with same inclination but crossing the equator at a different point would have a different value for α.

The value of the second geodesic parameter β § 316 increases with phase values progressing within a first range 362 from 0.636265 radians at phase of zero degrees (indicated by point 361 in FIG. 3) until the phase reaches approximately 162 degrees (indicated by point 363 in FIG. 3). At this point the second geodesic parameter β 316 approaches the maximum predetermined value of α+2π within its assigned range of β∈[α−2π, α+2π) described elsewhere herein. As the phase 302 approaches 163 degrees (indicated by point 364 in FIG. 3), the value of β 316 assumes the minimum predetermined value of α−2π within its assigned range of β∈[α−2π, α+2π). As the phase 302 increases from 162 degrees and approaches 360 degrees, progressing through a second range 365 of phase values, the value of β 316 increases (indicated by point 362 in FIG. 3) from its lowest value of α−2π radians. The value f of the second geodesic parameter corresponds to an angle, measured in radians, from the same reference point/location as for α, as described above.

In embodiments, the second parameter β is defined in terms of an additional geodesic parameter γ such that:

$$β = α + 2 γ . \qquad ( 1 )$$

Therefore, γ defines the half angle between α and β. A possible benefit of using such definition of β is to improve aspects (e.g. speed or accuracy) of a distance metric computation as a function of a phase of a node or destination in an orbit, as described further herein. Another possible benefit of using such definition of β is to facilitate predictability in determining a position of or assigning an address to a node or destination below and above the equator.

In embodiments, a phase ϕ of a node, location or destination is defined as its angular position measured from the first geodesic parameter in a plane containing the first geodesic. Therefore, α is defined as having phase ϕ of zero.

In embodiments, the first geodesic parameter α is predefined to represent an orbit of a node or destination. The following paragraphs describe determining the second geodesic parameter β by computing γ.

In embodiments, γ, and consequently β, may be determined using a rotation and projection approach. A transitory orbit represented as a circle may be defined in the x-y plane. A transitory position P_{xy} in the transitory orbit can be defined by its phase ϕ and expressed in Euclidian rectangular coordinates in three-dimensional Cartesian space as follows:

$${P}_{xy} = [ \begin{matrix}cos ϕ \\ sin ϕ \\ 0\end{matrix} ] .$$

Orbital inclination θ can be added to such transitory orbit, for example, by rotating it about the x-axis and multiplying by the rotational matrix Rx(θ) as follows:

$${P}_{θ} = {R}_{X} ( θ ) {P}_{xy} [ \begin{matrix}1 & 0 & 0 \\ 0 & cos θ & - sin θ \\ 0 & sin θ & cos θ\end{matrix} ] [ \begin{matrix}cos ϕ \\ sin ϕ \\ 0\end{matrix} ] = [ \begin{matrix}cos ϕ \\ cos θ sin ϕ \\ sin θ sin ϕ\end{matrix} ] ,$$

which can be projected along the z-axis to the equatorial plane to result in:

$${P}_{z} = [ \begin{matrix}cos ϕ \\ cos θ sin ϕ \\ 0\end{matrix} ] .$$

The value of the additional geodesic parameter γ is determined here as the angle from the x-axis as follows:

$$tan γ = \frac{cos θ sin ϕ}{cos ϕ} , \qquad ( 2 )$$

Equation (2) above may be solved using the atan 2 function, for example, to determine the value of γ. As will be readily understood by a worker skilled in the art, the atan 2 function computes the inverse tangent (arctangent) of a ratio value or value pair, taking into account the signs of both numerator and denominator in that ratio value or value pair.

In embodiments, therefore, the second parameter is based on, and changes with, an angular position (i.e. phase ϕ) of the node relative to the first parameter, the first parameter α representing location of the intersection of the equatorial plane with the first geodesic passing through the node or destination, phase ϕ being zero at this location, while the first parameter is constant for a given orbit of the node. The second parameter is further inherently based on the inclination θ of the orbital plane or orbit of the node.

In embodiments, a distance metric d representative of the distance between the first node or destination and the second node or destination, is calculated using the first geodesic parameter α and the additional geodesic parameter γ. The distance metric may be calculated according to the following formula:

$$Δ α = min ( \vert {α}_{1} - {α}_{2} \vert , 2 π - \vert {α}_{1} - {α}_{2} \vert ) , \qquad ( 3 )$$

$$Δ γ = min ( 2 \vert {γ}_{1} - {γ}_{2} \vert , 4 π - 2 \vert {γ}_{1} - {γ}_{2} \vert ) , \qquad ( 4 )$$

$$d = Δ α + Δ γ , \qquad ( 5 )$$

where α₁ is the first geodesic parameter of the first node or destination (e.g. candidate device or node), α₂ is the first geodesic parameter of the second node or (e.g. further or final) destination, γ₁ is half of a difference between the second geodesic parameter and the first geodesic parameter of the first node or destination (e.g. candidate device or node) as defined previously in Equation (1), and γ₂ is half of the difference between the second geodesic parameter and the first geodesic parameter of the second node or (e.g. further or final) destination as defined previously in Equation (1). It is noted that the computation of the distance metric may be performed in a variety of ways, for example according to a single step which represents an amalgamation of the above equations (3), (4), and (5). The computation may depend directly on β parameters (e.g. second geodesic parameter β₁ for the first node (e.g. candidate device or node) and second geodesic parameter β₂ for the second node or (e.g. further or final destination)) without requiring an explicit consideration of the respective γ parameters.

In embodiments, the additional parameter γ₁ is computed according to Equation (2) where θ is the orbital inclination of the first node or destination (e.g. candidate device or node), the second node or (e.g. further or final) destination, or both. Respective ϕ₁ is the angular position or phase of the first node or destination (e.g. candidate device or node) relative to a location corresponding to the first parameter α₁ of the first node or destination (e.g. candidate device or node). Additionally and similarly to γ₁, the further additional parameter γ₂ is computed according to Equation (2) where ϕ₂ is the angular position of the second node or (e.g. further or final) destination relative to a location corresponding to the further first parameter α₂ of the second node or (e.g. further or final) destination.

In embodiments, the distance metric is an L1 (Manhattan or taxicab) distance metric, as in the above-described case.

In other embodiments, the distance metric may be another type of distance metric, such as an L2 (Euclidean) distance metric, for example.

In embodiments, a distance metric satisfies axioms such as: the distance for a point to itself is zero; the distance between two distinct points is always positive; the distance from point x to point y is the same as the distance from y to x, and the triangle inequality holds.

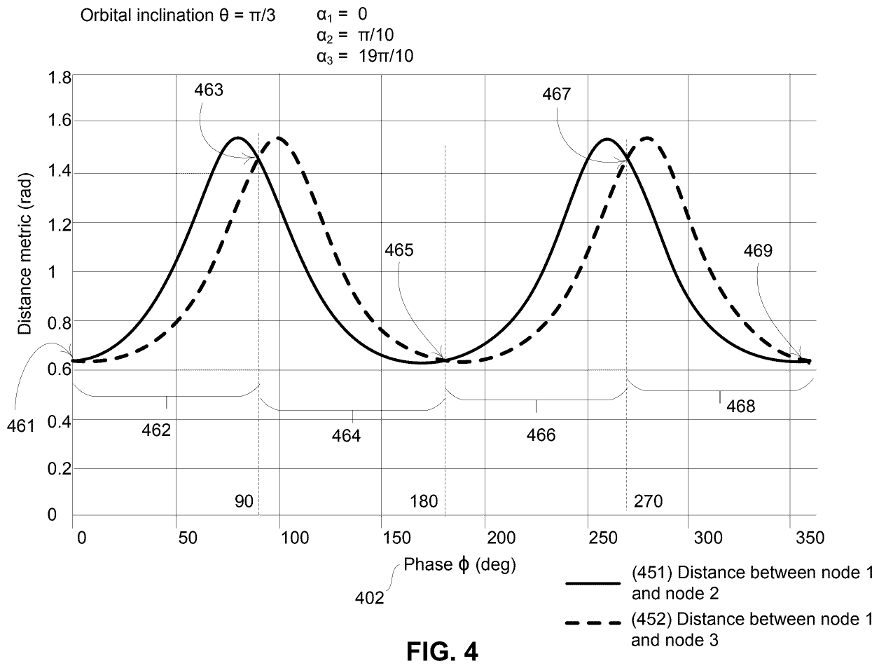

FIG. 4 shows a first distance metric 451 representative of a distance between an example orbiting node 1 and an orbiting node 2 and second distance metric 452 representative of a distance between orbiting node 1 and an orbiting node 3 as a function of node phase ϕ 402, determined according to the Equation (5) discussed above. Orbital inclination θ of each node is π/3. The first geodesic parameter α₁ of the node 1 is zero. The first geodesic parameter α₂ of the node 2 is π/10. The first geodesic parameter α₃ of the node 3 is 19π/10.

At phase ϕ of zero degrees, the first distance metric 451 between node 1 and node 2 is equal to the second distance metric 452 between node 1 and node 3 (indicated by point 461 in FIG. 4) and, therefore, node 2 and node 3 are considered to be equidistant from node 1.

As phase ϕ of each node increases from zero to 90 degrees and each node moves accordingly in its respective orbit, the first distance metric 451 between node 1 and node 2 is greater than the second distance metric 452 between node 1 and node 3 (corresponding to phase values in the range 462 in FIG. 4).

At phase ϕ of 90 degrees, the first distance metric 451 between node 1 and node 2 is again equal to the second distance metric 452 between node 1 and node 3 (indicated by point 463 in FIG. 4) and, therefore, node 2 and node 3 are considered to be equidistant from node 1 at this phase.

As phase ϕ of each node increases from 90 degrees to 180 degrees and each node moves accordingly in its respective orbit, the first distance metric 451 between node 1 and node 2 is less than the second distance metric 452 between node 1 and node 3 (corresponding to phase values in the range 464 in FIG. 4).

At phase ϕ of 180 degrees, the first distance metric 451 between node 1 and node 2 is again equal to the second distance metric 452 between node 1 and node 3 (indicated by point 465 in FIG. 4) and, therefore, node 2 and node 3 are considered to be equidistant from node 1 at this phase.

As phase ϕ of each node increases from 180 degrees to 270 degrees and each node moves accordingly in its respective orbit, the first distance metric 451 between node 1 and node 2 is again greater than the second distance metric 452 between node 1 and node 3 (corresponding to phase values in the range 466 in FIG. 4).

At phase ϕ of 270 degrees, the first distance metric 451 between node 1 and node 2 is again equal to the second distance metric 452 between node 1 and node 3 (indicated by point 467 in FIG. 4) and, therefore, node 2 and node 3 are considered to be equidistant from node 1 at this phase.

As phase ϕ of each node increases from 270 degrees to 360 degrees and each node moves to complete a full cycle in its respective orbit, the first distance metric 451 between node 1 and node 2 is again less than the second distance metric 452 between node 1 and node 3 (corresponding to phase values in the range 468 in FIG. 4).

At phase ϕ of 360 degrees, the first distance metric 451 between node 1 and node 2 is again equal to the second distance metric 452 between node 1 and node 3 (indicated by point 469 in FIG. 4) and, therefore, node 2 and node 3 are considered to be equidistant from node 1 at this phase. At this point, each node has completed a full circle in its respective orbit.

Further with respect to FIG. 4, if node 1 were the final (or further) destination and a current node had to determine whether to forward a packet to node 2 or node 3 (either of which would then forward the packet toward node 1), then the current node would pick node 3 for phase values in ranges 462 and 466, and would pick node 2 for phase values in ranges 464 and 468.

In embodiments, nodes including destination nodes or target nodes may be satellite-based nodes having the same orbital inclination, such as a Walker-Delta constellation or a polar constellation. A further or a final destination may also be a satellite-based node, for example as a part of the same constellation. In some embodiments, the further destination may be on a surface (e.g. of the Earth).

In embodiments, the distance metric can be used to represent a type of cost (to be minimized) associated with forwarding a packet to a node or destination. When such node or destination is an intermediate destination for further forwarding of the packet to a further destination, the cost or utility will, at least in part, depend on a distance (and corresponding distance metric) to the further destination from such intermediate node or destination. For example, when the intermediate node or destination is further from the further destination, it may be considered less desirable to route the data packet to that intermediate node or destination, resulting in higher cost. This is applicable as a metric whether or not the intermediate node or destination can transmit the data packet directly to the further destination (although scenarios can be contrived in which the total path length traversed by the data packet is not minimized under this “greedy” forwarding approach). Similarly, a utility to be maximized may be a decreasing function representative of such a distance.

More generally, given a data packet at a first location (e.g. first node), a cost or utility can be associated with forwarding the data packet to a destination device, such as an intermediate node or destination, directly communicatively coupled to the first location in possession of the data packet. This can be further generalized, in some instances, to destination devices indirectly coupled to the first location. However, for simplicity, only direct couplings are considered herein. Once such costs or utilities are determined, the destination device associated with a relatively low (or lowest) cost, or a relatively high (or highest) utility can then be selected and the data packet can be forwarded to the selected destination device. In dynamic networks such as orbiting satellite constellations or networks in which destination devices move frequently, the costs or utilities can be updated as needed. In general, costs or utility metrics can reflect distance, signal quality, charges levied, bandwidth limitations, quality of service or fairness limitations, etc.

In embodiments, determining the cost or utility includes computing a distance metric from each candidate (e.g. being within forwarding range of the first node in possession of the data packet) node to the further or final destination using the location of candidate node and the location of the further or final destination. Respective distance metric is computed using respective locations of candidate nodes and the further or final destination defined by respective further first (geodesic) parameters (α₂) and further second (geodesic) parameters (β₂). That is, the further destination or final destination has location specified according to a further first parameter and a further second geodesic parameter (or a further additional geodesic parameter γ₂), which are instances of the first (α) and second (β) (or additional, γ) geodesic parameters described herein, applicable to this further (or final) destination.

In embodiments, locations of candidate nodes and the further or final destination for distance metric computation may be defined by respective first (geodesic) parameters (α) and respective additional (geodesic) parameters (γ).

A node may be selected from such candidate nodes for forwarding the data packet to based at least in part on the determined costs or utilities. Then the packet may be forwarded to the selected candidate node.

A routing system typically consists of different subsystems. Two notable subsystems are referred to herein as the control plane and the forwarding plane. The forwarding plane is also sometimes called the user plane or the data plane. The control plane is responsible for monitoring the network topology and building routes. These routes may be programmed into the forwarding table, which uses them to actually forward the packets. The forwarding table is often implemented in hardware for higher performance systems, and in software (for example, Linux includes an IP forwarding plane in the kernel) for lower performance systems.

In embodiments, the forwarding plane makes use of a forwarding table that is configured with a list of data entries (tuples), each containing a destination address and a corresponding interface. To forward a packet to a given destination address, the corresponding interface is used. Interfaces may correspond to particular optical or radio communication links, for example. Interfaces can be free space optical links between nodes, for example. Different interfaces may map to different communication links. Interfaces can correspond to virtual interfaces, which in turn may correspond to one or more physical interfaces. The destination address may contain a location defined in terms of geodesic parameters described herein and potentially other routing information. The destination address may indicate a physical location rather than a network-based location (e.g. numerical identifiers in a list of successive subnets). For example, the physical location can be included in the address in a predetermined format representing the first and second (or additional) geodesic parameters of the location. That is, a header field can include a value that can be mapped, according to a predetermined rule, to a physical location for example on a spherical surface.

In embodiments, a physical location included in a destination address of a packet may be converted into geodesic coordinates for cost or utility (e.g. distance metric) computations, packet routing and forwarding, or both.

Physical locations of destination devices or further destinations and their corresponding geodesic coordinates may be fixed or variable. For example, satellites in low Earth orbit may have variable location with respect to a coordinate system, such as but not limited to a latitude/longitude coordinate system. Satellite physical locations may be updated for example based on ephemeris or almanac data, or by reporting or observation, or a combination thereof.

In embodiments, an address in a packet header or a node or destination address includes the first geodesic parameter α.

In embodiments, an address in a packet header or a node or destination address may include, e.g. in addition to the first geodesic parameter α, the second geodesic parameter β, the additional geodesic parameter γ, or both.

When the forwarding plane is operating, it will receive a stream of packets to be forwarded (for example at a rate on the order of 108 packets per second). For each packet, the forwarding plane is configured to inspect the list of destination addresses, select a set of addresses with minimum cost or maximum utility according to a metric such as a distance-based metric, and then select one of those addresses to which to forward the packet. The interface associated with the address is used for forwarding the packet.

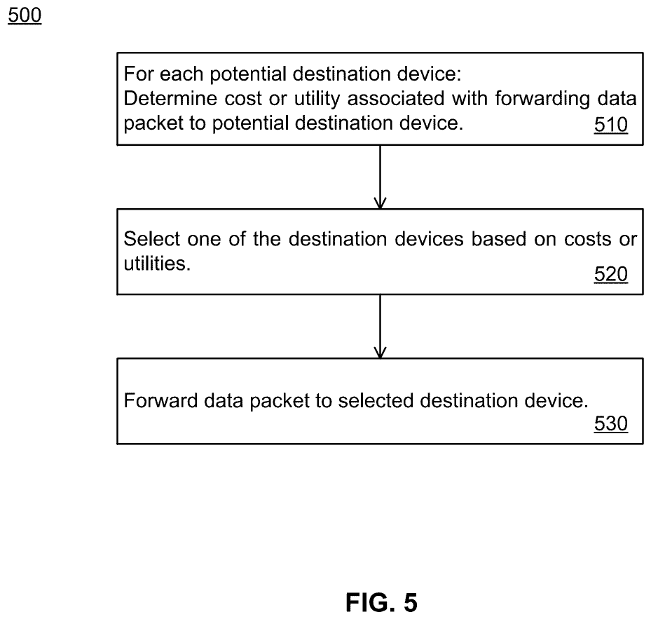

Accordingly, and with reference to FIG. 5, embodiments of the present disclosure provide for a method 500 for routing a data packet in a network. The method may be implemented in the forwarding plane. The method includes, for each one of a plurality of destination devices capable of further handling of the data packet for routing toward a further destination, determining 510 a respective cost or utility associated with forwarding the data packet to that one of the plurality of destination devices. The method further includes selecting 520 one of the plurality of destination devices based at least in part on the determined costs or utilities. For example, the destination device with the lowest cost (or the highest utility) may be selected. The method further includes forwarding 530 the data packet to the selected destination device.

It is noted that the cost or utility can be a cost or utility associated with forwarding the data packet from the associated one of the plurality of destination devices (or a node) toward a potentially final (referred to as further) destination or node. The cost or utility may be based on a distance metric representative of a distance from the associated one of the plurality of destination devices to the further destination. The distance metric is determined using the geodesic parameters, as described elsewhere herein.

In various embodiments, selecting the particular one of the plurality of destination devices is performed using a comparator tree. The comparator tree typically includes multiple stages, each stage having one or more comparators configured to compare pairs of costs or utilities and output an indication of a lower of compared costs or a higher of compared utilities. It is noted that a comparator tree can determine a smallest (or largest) value out of n values using approximately n stages of comparators.

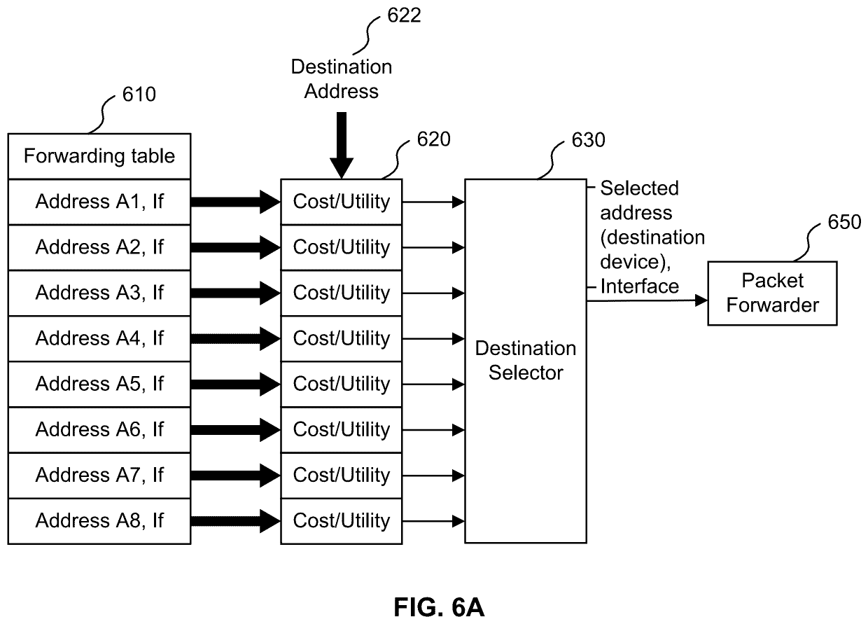

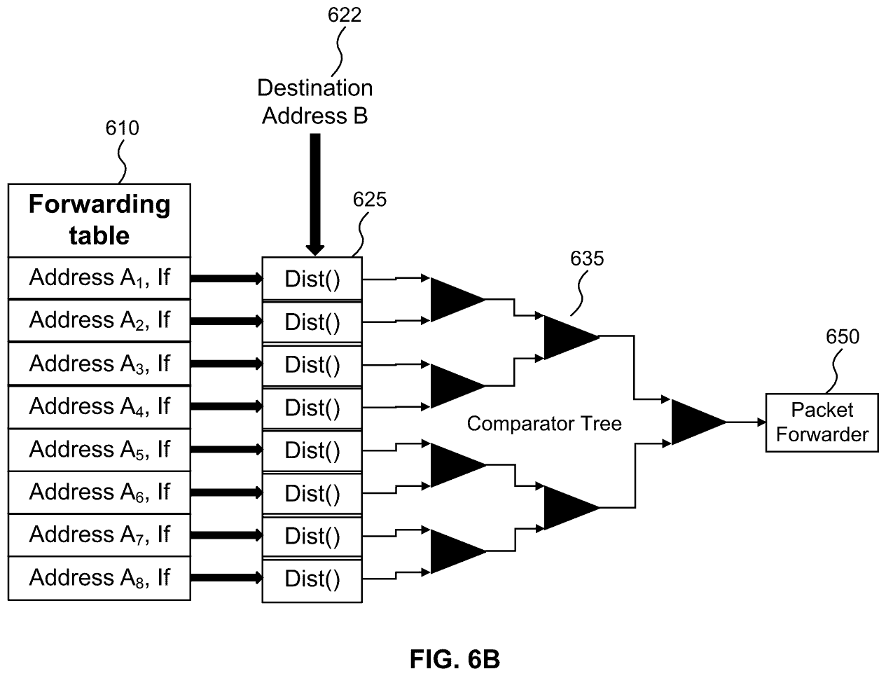

FIG. 6A is a block diagram illustrating forwarding plane operation, according to an embodiment of the present disclosure. A forwarding table 610 contains a set of destination device or node addresses and the corresponding interfaces usable to forward packets to such destination devices or nodes. Although eight destination devices addresses are shown, more or fewer addresses may be present. A cost or utility determiner 620 is provided and configured, for each destination device or node address, to determine the respective cost or utility associated with forwarding the data packet to that destination device or node. As mentioned above, the cost may correspond to or otherwise be based on distance metric from the destination device or node to a further (e.g. final) destination device. The address 622 of the further destination device may be provided, if necessary, and may be converted, if necessary, to include geodesic parameters. The costs or utilities may be determined based on the address (which may indicate a physical location). Determining the costs or utilities may include converting, if needed, to an address comprising geodesic parameters. A destination selector 630 receives the destination device addresses and costs/utilities and selects a destination device based on cost or utility, for example selecting a destination device for which costs are lowest or utilities are highest. Once a destination device is selected, a packet forwarder 650 receives the indication of destination device (and associated interface) and forwards the packet toward that destination device.

In embodiments, an apparatus for forwarding a data packet in a network includes a cost determiner that, for each node or device capable of further handling of the data packet for routing toward a further (e.g. final, packet header) destination, determines a respective cost or utility associated with forwarding the data packet to such a node or device. The cost or utility wherein is determined at least in part by computing a distance metric from the node or device and the further destination using the location of the node or device and the location of the further destination.

In embodiments, the further (e.g. final) destination address as well as the destination device or node addresses include geodesic parameters (i.e. respective first geodesic parameter, and second and/or additional geodesic parameter).

In embodiments, the apparatus includes a destination selector configured to receive the determined costs or utilities from the cost determiner and select a node or device based at least in part on such determined costs or utilities.

In embodiments, the apparatus includes a packet forwarder configured to receive an indication of the selected node or device from the destination selector and forward the data packet to the selected node or device.

FIG. 6B illustrates a particular variant of the embodiment of FIG. 6A, in which the cost or utility determiner 620 is replaced with a distance determiner 625. The distance determiner receives the indication 622 of the further destination address and determines the distance metric from each address in the forwarding table to the further destination address using respective first and second geodesic parameters.

Further with respect to FIG. 6B, the destination selector 630 of FIG. 6A is replaced with a comparator tree 635. In an embodiment, the comparator tree includes multiple two-input, single-output comparators arranged together and cooperatively configured to select the destination address with lowest determined cost, which as least in part includes the smallest distance metric. This is achieved by outputting, by each comparator, the destination address associated with the lowest cost between the two destination addresses input to that comparator. In another embodiment, the comparators may be configured to select the destination address with highest determined utility. This is achieved by outputting, by each comparator, the destination address associated with the highest utility between the two destination addresses input to that comparator. It is noted that the distance determiner can be used with other types of destination selectors, and likewise the comparator tree can be used with other types of cost determiners.

It is noted that, while the comparator tree is shown as comparing and passing values (e.g. costs or utilities), ancillary information, such as network addresses or pointers to network addresses, can be attached to these values and passed along with the values. That is, the ancillary information follows the values through the comparator tree network but does not affect the outcome of the comparator operations, either because it is ignored by the comparators or because its weight in the overall value does not affect outcome of comparator operations.

Embodiments of the present disclosure can be implemented using electronics hardware, software, or a combination thereof. In some embodiments, the forwarding plane is implemented by one or multiple computer processors executing program instructions stored in memory. In some embodiments, the forwarding plane is implemented partially or fully in hardware, for example using one or more field programmable gate arrays (FPGAs) or application specific integrated circuits (ASICs) to rapidly perform the processing operations required for implementing forwarding plane operations. The forwarding plane operations can include determining costs or utilities associated with forwarding a data packet to destination devices, determining (e.g. using a comparator tree) destination devices having lowest cost or highest utility, and forwarding of a data packet to the destination device. The determining of a destination device can be performed using sorting and selection hardware which can include comparators as described above for example with respect to FIGS. 6A and 6B. The hardware or software overall can have the architecture described above for example with respect to these same figures. Computations can be performed by a computer processor, or equivalent analog, digital or hybrid circuitry, or using one or more lookup tables, or the like, or a combination thereof.

Embodiments of the present disclosure, for example those realized in a hardware rather than computer processor implementation, can be implemented using a highly parallel forwarding plane architecture. For example, costs or utilities for multiple destinations can be determined in parallel, and multiple comparator operations in each stage of the comparator tree can be performed in parallel. This facilitates a rapid operation of the forwarding plane. Embodiments of the present disclosure combine a distance metric function with a comparator tree implementation to perform forwarding plane operations at line rates.

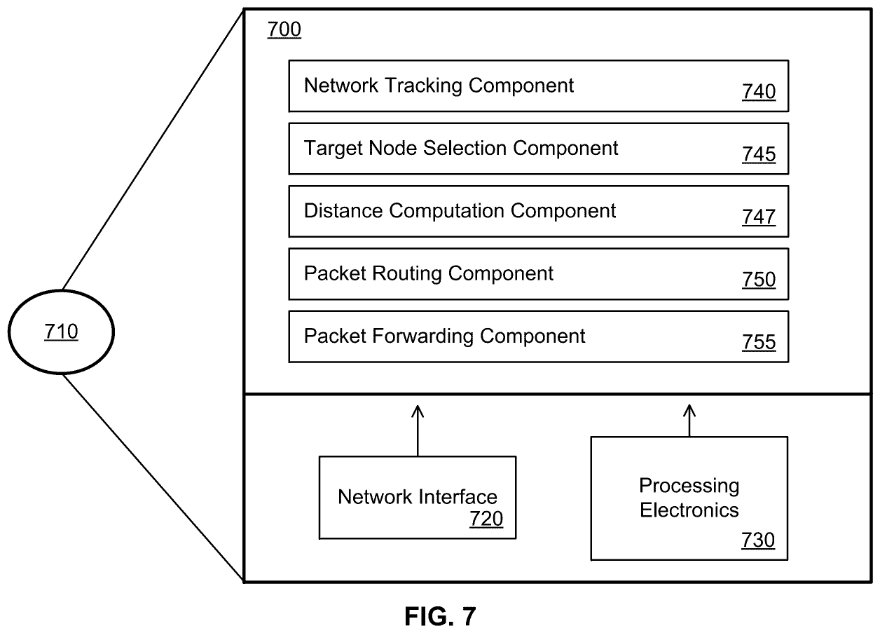

FIG. 7 illustrates an apparatus 700 for routing a data packet in a network, according to embodiments of the present disclosure. The apparatus is located at a node 710 of the network in possession of the data packet, such as but not necessarily limited to a satellite-based node. The apparatus includes a network interface 720 and processing electronics 730. The processing electronics can include a computer processer executing program instructions stored in memory, or other electronics components such as digital circuitry, including for example FPGAs and ASICs. The network interface can include an optical communication interface or radio communication interface, such as a transmitter and receiver. The apparatus can include several functional components, each of which is partially or fully implemented using the underlying network interface 720 and processing electronics 730.

The apparatus includes a network tracking component 740 which is configured to maintain current information regarding a limited portion of the network directly coupled to the node 710. The information can include physical location information comprising respective first and second (or additional) geodesic parameters for nodes or destination devices in the limited portion of the network, and routing information for the limited portion of the network. The information can be maintained through receiving and processing control plane messages indicative of current network conditions, through predicting changes in network conditions based on internal models, or a combination thereof. The apparatus includes a target node or destination device selection component 745. The target node or destination device selection component is configured to select, from among the nodes or destination device in the limited portion of the network, a target node or destination device that meets a given objective with respect to the distance metric to the location of the destination for the data packet. This may involve selecting the target node or destination device as the node or destination device which is closest (i.e. having the smallest distance metric) to the packet destination location, or selecting the target location or destination device from among the k nodes or destination devices which are closest to the packet destination location.

The apparatus may include a distance computation component 747, which may be part of the target node or destination device selection component 745 or a separate component coupled thereto. The distance computation component is configured to the determine distance metric between pairs of network nodes or destination devices, or between network nodes or destination devices and packet destination locations (also referred to as further destinations).

The apparatus further includes a packet routing component 750 which is configured to determine, based on the routing information, a next node or destination device belonging to the limited portion of the network and located along an available network path between the node or destination device and the target node or target destination device. The next node or next destination device can be determined based on a routing table, which selects the next node or next destination device based on the target node or target destination device. The routing table can be maintained by the network tracking component 740, based on the current network information. For this purpose, for example, the network tracking component can maintain the routing table in accordance with a shortest path first algorithm, which determines shortest paths (e.g. represented by smallest distance metrics) to potential target nodes or target destination devices, and associates these with appropriate next nodes or next destination devices along respective shortest paths to target nodes or target destination devices.

The apparatus further includes a packet forwarding component 755 which is configured to forward the packet toward the next node using the network interface 720.

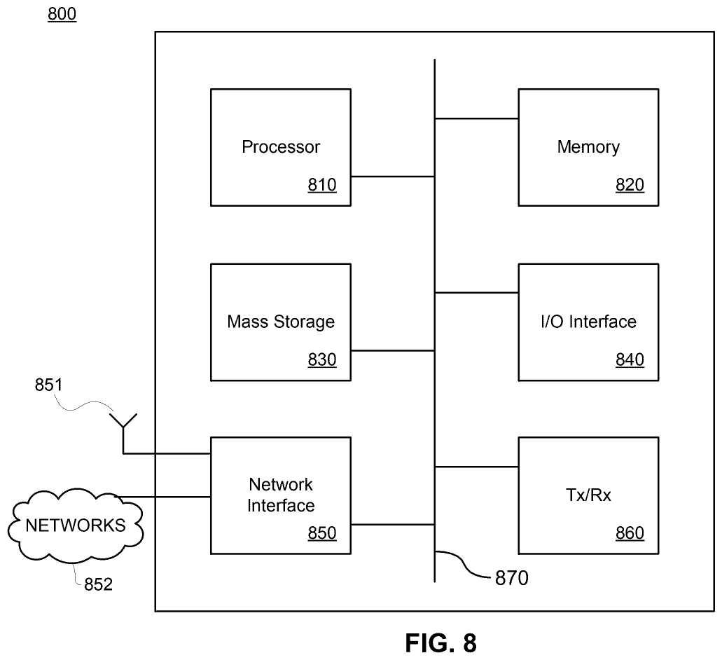

FIG. 8 shows a schematic diagram of an electronic device 800 that may perform any or all of the operations of the above methods and features explicitly or implicitly described herein, according to different embodiments of the present disclosure. For example, a computer equipped with network function may be configured as electronic device 800. The electronic device 800 may be used to implement the apparatus 800 of FIG. 7, for example.

As shown, the electronic device 800 may include a processor 810, such as a Central Processing Unit (CPU) or specialized processors such as a Graphics Processing Unit (GPU) or other such processor unit, memory 820, network interface 850, and a bi-directional bus 870 to communicatively couple the components of electronic device 800. Electronic device 800 may also optionally include non-transitory mass storage 830, an I/O interface 840, and a transceiver 860. According to certain embodiments, any or all of the depicted elements may be utilized, or only a subset of the elements. Further, the electronic device 800 may contain multiple instances of certain elements, such as multiple processors, memories, or transceivers. Also, elements of the hardware device may be directly coupled to other elements without the bi-directional bus 870. Additionally or alternatively to a processor and memory, other electronics, such as integrated circuits, may be employed for performing the required logical operations.

The memory 820 may include any type of tangible, non-transitory memory such as static random access memory (SRAM), dynamic random access memory (DRAM), synchronous DRAM (SDRAM), read-only memory (ROM), any combination of such, or the like. The mass storage element 830 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method operations described above.

Network interface 850 may include at least one of a wired network interface and a wireless network interface. The network interface 850 may include a wired network interface 852 to connect to a communication network and may also include a radio access network interface 851 for connecting to the communication network or other network elements over a radio link. The network interface 850 enables the electronic device 800 to communicate with remote entities such as those connected to the communication network.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for routing a data packet in a network, the method comprising:
for each one of a plurality of destination devices capable of further handling of the data packet for routing toward a further destination, determining a respective cost or utility associated with forwarding the data packet to said one of the plurality of destination devices,
said one of the plurality of destination devices having a location defined by:
a first parameter α₁ representing location of an intersection of an equatorial plane with a first geodesic passing through said one of the plurality of destination devices; and
a second parameter β₁ representing location of an intersection of the equatorial plane with a second geodesic passing through said one of the plurality of destination devices,
said further destination having a location,
wherein determining the cost or utility comprises computing a distance metric from said one of the plurality of destination devices to the further destination using the location of said one of the plurality of destination devices and the location of said further destination;
selecting one of the plurality of destination devices based at least in part on the determined costs or utilities; and
forwarding the data packet to said selected one of the plurality of destination devices.

2. The method of claim 1, wherein the location of said further destination is defined by
a further first parameter α₂ representing an intersection of the equatorial plane with a further first geodesic passing through the further destination, and
a further second parameter β₂ representing an intersection of the equatorial plane with a further second geodesic passing through the further destination.

3. The method of claim 1, wherein said selecting one of the plurality of destination devices comprises selecting a particular one of the plurality of destination devices having a lowest cost or highest utility.

4. The method of claim 1, wherein selecting said one of the plurality of destination devices comprises using a comparator tree, the comparator tree having multiple stages, each stage having one or more comparators configured to compare pairs of said costs or utilities and output an indication of a lower of compared costs or a higher of compared utilities.

5. The method of claim 1, wherein at least one of: the plurality of destination devices; and the further destination is a satellite-based network node.

6. The method of claim 1, wherein a plane comprising the first geodesic passing though the one or more of the plurality of destination devices is representative of an orbital plane of at least one of the one or more of the plurality of destination devices.

7. The method of claim 1, wherein the second parameter β₁ is based on an angular position ϕ₁ of said one of the plurality of destination devices, the angular position ϕ₁ being relative to a location corresponding to the first parameter α₁.

8. The method of claim 6, wherein the second parameter β₁ is based on an inclination θ of the orbital plane of said at least one of the one or more of the plurality of destination devices.

9. The method of claim 1, wherein the plurality of destination devices belongs to the network, each of the plurality of destination devices following a respective orbit having a same orbital inclination θ.

10. The method of claim 2, wherein the distance metric d is computed according to:
$$Δ α = min ( \vert {α}_{1} - {α}_{2} \vert , 2 π - \vert {α}_{1} - {α}_{2} \vert ) ,$$
$$Δ γ = min ( 2 \vert {γ}_{1} - {γ}_{2} \vert , 4 π - 2 \vert {γ}_{1} - {γ}_{2} \vert ) ,$$
$$d = Δ α + Δ γ ,$$
wherein α₁ is the first parameter, α₂ is the further first parameter, and γ₁ is an additional parameter defined such that:
$${β}_{1} = {α}_{1} + 2 {γ}_{1}$$
wherein β₁ is the second parameter, and γ₂ is a further additional parameter defined such that:
$${β}_{2} = {α}_{2} + 2 {γ}_{2}$$
wherein β₂ is the further second parameter.

11. The method of claim 10, wherein the additional parameter γ₁ is computed according to:
$$tan {γ}_{1} = \frac{cos θ sin {ϕ}_{1}}{cos {ϕ}_{1}}$$
wherein θ is an orbital inclination of said one of the plurality of destination devices or said further destination, or both, and ϕ₁ is an angular position of said one of the plurality of destination devices relative to a location corresponding to the first parameter α₁; and
wherein the further additional parameter γ₂ is computed according to:
$$tan {γ}_{2} = \frac{cos θ sin {ϕ}_{2}}{cos {ϕ}_{2}}$$
wherein ϕ₂ is an angular position of said further destination relative to a location corresponding to the further first parameter α₂.

12. The method of claim 1, wherein the first geodesic and the second geodesic intersect at one of: vertically below; vertically above and at said one of the plurality of destination devices.

13. The method of claim 1, wherein each parameter represents an angle measured in the equatorial plane from a common reference location to each respective intersection of the equatorial plane with the respective geodesic passing through said one of the plurality of destination devices.

14. An apparatus for forwarding a data packet in a network, the apparatus comprising:
a cost determiner configured, for each one of a plurality of destination devices capable of further handling of the data packet for routing toward a further destination, to determine a respective cost or utility associated with forwarding the data packet to said one of the plurality of destination devices,
said one of the plurality of destination devices having a location defined by:
a first parameter representing location of an intersection of an equatorial plane with a first geodesic passing through said one of the plurality of destination devices; and
a second parameter representing location of an intersection of the equatorial plane with a second geodesic passing through said one of the plurality of destination devices,
said further destination having a location,
wherein the cost or utility is determined at least in part by computing a distance metric from said one of the plurality of destination devices and the further destination using the location of said one of the plurality of destination devices and the location of said further destination;
a destination selector configured to receive the determined costs or utilities from the cost determiner and select one of the plurality of destination devices based at least in part on the determined costs or utilities; and
a packet forwarder configured to receive an indication of said selected one of the plurality of destination devices from said destination selector and forward the data packet to said selected one of the plurality of destination devices.

15. The apparatus of claim 14, wherein the location of said further destination is defined by
a further first parameter representing location of an intersection of the equatorial plane with a further first geodesic passing through the further destination, and
a further second parameter representing location of an intersection of the equatorial plane with a further second geodesic passing through the further destination.

16. The apparatus of claim 15, wherein the distance metric d is computed according:
$$\begin{matrix}Δ α = min ( \vert {α}_{1} - {α}_{2} \vert , 2 π - \vert {α}_{1} - {α}_{2} \vert ) \\ Δ γ = min ( 2 \vert {γ}_{1} - {γ}_{2} \vert , 4 π - 2 \vert {γ}_{1} - {γ}_{2} \vert ) \\ d = Δ α + Δ γ\end{matrix}$$
wherein α₁ is the first parameter, α₂ is the further first parameter, and γ₁ is an additional parameter defined such that:
$${β}_{1} = {α}_{1} + 2 {γ}_{1}$$
wherein β₁ is the second parameter, and γ₂ is a further additional parameter defined such that:
$${β}_{2} = {α}_{2} + 2 {γ}_{2}$$
wherein β₂ is the further second parameter.

17. The apparatus of claim 16, wherein the additional parameter γ₁ is computed according to:
$$tan {γ}_{1} = \frac{cos θ sin {ϕ}_{1}}{cos {ϕ}_{1}}$$
wherein θ is an orbital inclination of said one of the plurality of destination devices or said further destination, or both, and ϕ₁ is an angular position of said one of the plurality of destination devices relative to a location corresponding to the first parameter α₁; and
wherein the further additional parameter γ₂ is computed according to:
$$tan {γ}_{2} = \frac{cos θ sin {ϕ}_{2}}{cos {ϕ}_{2}}$$
wherein ϕ₂ is an angular position of said further destination relative to a location corresponding to the further first parameter α₂.

18. The apparatus of claim 14, wherein one or both of the cost determiner and the destination selector is implemented using a processor operatively coupled to a memory, the memory storing program instructions that, when executed by the processor, cause the processor to implement said one or both of the cost determiner and the destination selector.

19. The apparatus of claim 14, wherein one or both of the cost determiner and the destination selector is implemented using dedicated data processing hardware.

20. A method for assigning an address to a node in a network, the method comprising:
determining a first parameter representing location of an intersection of an equatorial plane with a first geodesic passing through the node;
determining a second parameter representing location of an intersection of the equatorial plane with a second geodesic passing through the node;
assigning the address so as to include the first parameter and the second parameter.
